(19) United States
(12) Patent Application Publication
(10) Pub. No.: US 2005/0282726 A1
(43) Pub. Date: Dec. 22, 2005

(54) Fabric treatment

(75) Inventors: Robert John Carswell, Bebington (GB); Stephen Golding, Bebington (GB); Paul Kravchuk, Bebington (GB); David Moorfield, Bebington (GB); Zongxing Qiu, Shanghai (CN); Su De-Bao, Shanghai (CN); Jane Whittaker, Bebington (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a UNILEVER

(21) Appl. No.: 11/158,767

(22) Filed: Jun. 22, 2005

(30) Foreign Application Priority Data
Jun. 22, 2004 (GB) 0413889.7

(51) Int. Cl. C11D 1/00

(52) U.S. Cl. 510/470

(57) ABSTRACT

Excellent cross-linking benefits, to improve wrinkle recovery can be obtained in laundry treatment by use of a triazine-based, cellulose cross-linking agent that has a highly flexible linking group between at least two, mono-reactive cross-linking moieties and cellulose unreactive substituent groups. The linking group acts as a ‘spring’ whereas the two end groups bind chemically to cotton fibres.

### TECHNICAL FIELD

The present invention relates to Fabric Treatment compositions, and in particular to compositions which contain components which can cross-link with cellulose.

### BACKGROUND OF THE INVENTION

Cellulose is a beta 1-4 linked polysaccharide and the principal component of cotton, which is a well-known material for the production of fabrics and in very widespread use. Cellulose is capable of cross-linking by hydrogen bonds which form between the cellulose chains.

The majority of garments purchased world-wide contain at least some cellulose fibres in the form of cotton or rayon and these suffer from the well-known problem that on exposure to water, such as during laundering, fibre dimensions change and cause shrinking and wrinkling of the garments. It is believed that this is due to release and reformation of hydrogen bonds.

So-called ‘durable press’ treatments of fabrics are intended to overcome these difficulties. One of the most common methods of durable pressing uses a crosslinking agent to immobilise cellulose at a molecular level. Known cross-linking agents include formaldehyde, and urea-glyoxal resins. Other proposals include epichlorohydrins, vinyl sulphones, triazines, acryloamide and acryloacrylates. None of these proposed technologies have demonstrated real commercial viability to date.

A preferred durable press system should be a non-toxic, have low iron-cure times, have some affinity for the fabric surface and not cause fabric strength losses.

U.S. Pat. No. 6,036,731 (Ciba Speciality Chemicals: 1998) discloses a very general cross-linking material for cellulose, of the structure A-Rₙ, where A is a colourless radical (which can be, amongst others, alkoxy) and R includes at least two fibre reactive groups (which can be, amongst others, a asymmetrical or symmetrical triazine ring).

WO 01/23660 and WO 01/23661 (P&G: 1999) disclose fabric treatment compositions comprising a triazine based fabric modifying compound.

### BRIEF DESCRIPTION OF THE INVENTION

We have determined that excellent cross-linking benefits can be obtained in laundry treatment by use of a triazine-based, cellulose cross-linking agent that has a highly flexible linking group between at least two, mono-reactive cross-linking moieties.

Accordingly, the present invention provides a laundry treatment composition comprising:
a) a textile compatible carrier,
b) an acid binding agent
c) a cellulose cross linking agent which is water soluble or soluble in a water miscible solvent
   in which the cellulose cross-linking agent comprises two or more mono-reactive s-triazine moieties bridged by a flexible bridging moiety, said bridging moiety comprising at least one aliphatic polyoxyalkylene chain, and wherein each s-triazine moiety is provided with a hydrophilic or a non-hydrophilic substituent group.

A highly preferred form of the cellulose cross-linking agents can be represented by the general structure (1):
(R₁)(X₁)T-L₁-B-L₂-T(X₂)(R₂) (1)
wherein:

R1 and R2 are cellulose-unreactive substituent groups on the s-triazine (T) and may be the same or different,

X1 and X2 are leaving groups on the s-triazine which are lost on reaction with cellulose and may be the same or different,

L1 and L2 are linking groups, and may be the same or different or absent,

B is the bridging group comprising or consisting of at least one aliphatic polyoxyalkylene chain.

The present invention also relates to these compounds per se.

Polymeric cross-linkers in which R2 is replaced by a serial repeat of the rest of the molecular structure are also envisaged. However bi-functional molecules comprising a single linking chain with two reactive end-groups are preferred.

It is important that the bridging moiety (B) is flexible and allows relatively free independent movement of the s-triazine groups that it connects. Typically it will be 2-100 atoms in length.

Suitable bridging moieties include: Ethylene glycol, Diethylene glycol, Triethylene glycol, Tetraethylene glycol, Pentaethylene glycol, Hexaethylene glycol, other poly(ethylene glycol), Propylene glycol, Dipropylene glycol, Tripropylene glycol other poly(propylene glycol), Jeffamine D-230™ (ex. Huntsman), Jeffamine D-400™ (ex. Huntsman), Jeffamine EDR-148™ (Triethylene glycol diamine) (ex. Huntsman), 2,2′-Oxy(bisethylamine) and Tetraethylene glycol amine.

Preferably the bridging moiety is polyethylene glycol or polypropylene glycol or mixed C2/C3 polyglycol. Particularly preferred bridging moieties comprise 1-10, more preferably 1-7, ethylene and/or propylene glycol units.

The bridging group (B) can be joined to the s-triazine through either an oxygen or a nitrogen linkage. Compounds according to the present invention with —HN— linked bridging groups can be derived by reaction of amine terminated polyoxyalkylenes with cyuranic chloride and subsequent reaction with a hydroxy acid. A suitable amine terminated polyoxyalkylene is Jeffamine D-400™ (ex Huntsman). Compounds with —O— linking groups can be prepared by the reaction of polyoxyalkyenes with cyuranic chloride to form the dichloro triazine derivative and subsequent reaction with a —O— linking substituent (such as a hydroxy acid) or —NH— linking substituent such as an amino acid (such as glycine or taurine).

Each s-triazine moiety is preferably a mono-chloro triazine. The chlorine atom is displaced during the reaction (as hydrogen chloride) with cellulose and reacts with the acid binding agent.

Suitable acid binding agents may be organic, for example tertiary amine bases or inorganic, such as alkali metal carbonates, alkaline earth metal carbonates, alkali metal hydroxides, alkaline earth metal hydroxides and mixtures thereof. Preferred acid binding agents include alkali-metal carbonates and hydrogen-carbonates, particularly sodium carbonate and sodium hydrogen carbonate.

Alternative cellulose-reactive leaving groups (X1, X2) to chlorine can be employed. These include other halogen, thioglycolate, citrate, nicotinate, (4-sulphonyl-phenyl)amino, (4-sulphonylphenyl)oxy, and mixtures thereof.

The mono-reactive nature of the s-triazines ensures that only single cross-linking events occur at each triazine group. This significantly reduces loss of integrity of the fabric being treated.

Each s-triazine moiety is provided with a hydrophilic substituent (R1, R2).

The substituent (R1, R2) may be linked through, a heteroatom, preferably a nitrogen, sulfur or an oxygen linkage. Suitable substituent groups include polyethers and quaternerised amine derivatives (for example hydroxy amines). Preferred hydrophilic substituents include hydroxy acids, amino acids, mercaptans and amino-sulphonates, each in their salt forms. Mixtures of these substituent groups can be used. In the alternative, the substituent can be low molecular weight non-hydrophilic moiety, preferably with a chain length of from C1 to C10, more preferably of from C1 to C4 and most preferably of from C1 to C3 (such as a methoxy group or a propyl amine) if the flexible bridging moiety (B) comprises a sufficiently long polyoxyalkylene chain to provide sufficient hydrophilicity.

Particularly preferred hydrophilic substituents include
a) Amino acids. It is preferred that the amino acid is in salt form (for example sodium or potassium salt). Both natural and non-natural amino acids are included, for example:
   natural amino acids include: Glycine, Alanine, Valine, Leucine, Isoleucine, Serine, Lysine, Proline, Aspartic Acid, Glutamic Acid, Cysteine, Arginine, Asparagine, Glutamine, Histadine, Methionine, Threonine, Phenyl alanine, Tryptophan, Tyrosine
   Non-natural amino acids include: Iminodiacetic acid, 2-Aminobutyric acid, 2-(methylamino)isobutyric acid, 2-Aminobutyric acid, Tert-leucine, Norvaline, Norleucine, 2,3-Diaminopropionic acid, 2-Aminocaprylic acid, β-Alanine, 3-Aminoisobutyric acid, 4-Aminobutyric acid, 5-Aminovaleric acid, Homoserine, 4-Amino-3-hydroxybutyric acid, 5-Aminolevulinic acid, 5-Hydroxy-DL-lysine, 1-Amino-1-cyclopropane carboxylic acid, 2,3-Diaminopropionic acid, DL-2,4-diaminobutyric acid, Ornithine, 2-Methylglutamic acid, 2-Aminoadipic acid, Penicillamine, Homocysteine, Cystine, Methyl cysteine, Ethionine, and S-Carboxymethyl-L-cysteine
b) Hydroxy acids. It is again preferred that the hydroxy acid is in salt form (for example sodium or potassium salt). Examples of suitable hydroxy acids are:
   Glycolic acid, Lactic acid, 2-Hydroxyisobutyric acid, 3-Hydroxybutyric acid, 2-Hydroxy-2-methylbutyric acid, 2-Ethyl-2-hydroxybutyric acid, 2-Hydroxyisocaproic acid, 2-Hydroxycaproic acid, 2,2-Bis(hydroxymethyl)propionic acid, Gluconic acid, Malic acid, Citramalic acid, 2-Isopropylmalic acid, 2-Isopropylmalic acid, 3-Hydroxy-3-methylglutaric acid, Tartaric acid, Mucic acid, and Citric acid
c) Mercaptans. It is again preferred that the mercaptan is in salt form (for example sodium or potassium salt). Examples of mercaptans include: Mercaptoacetic acid, Thiolactic acid, 3-Mercaptopropionic acid and Mercaptosuccinic acid
d) Sulphonates. It is preferred that the sulphonate is in salt form (for example sodium or potassium salt). Examples of sulphonates include: Formaldehyde sodium bisulfite addition compounds, Isethionic acid, 3-Hydroxy-1-propanesulphonic acid, 2-Mercaptoethanesulphonic acid,3-Mercapto-1-propanesulphonic acid, Aminomethanesulphonic acid, 3-Amino-1-propanesulphonic acid, and, Taurine
e) Quaternerised Amine Derivatives: These include Quaternerised derivatives of the following amines (known quaternerising agents include CH₃I, CH₃Cl, (CH₃)₂SO₄): N,N-Dimethylethanol amine, N,N-Diethylethanol amine, 2-(Diisopropylamino)ethanol, 2-(Dibutylamino)ethanol, 3-Dimethylamino-1-propanol, 3-Diethylamino-1-propanol, 2-Dimethylamino-2-methyl-1-propanol, 2-[2-(Dimethylamino) ethoxy]ethanol, 2-Dimethylaminoethanethiol, 2-Diethylamino-ethanethiol, 1-(2-Aminoethyl)pyrrolidine, 2-(2-Aminoethyl)-1-methylpyrrolidine, 1-Methyl-2-piperidinemethanol
f) Polyethers. Suitable materials include: Ethylene glycol, Diethylene glycol, Triethylene glycol, Tetraethylene glycol, Pentaethylene glycol, Hexaethylene glycol, other poly(ethylene glycol), Propylene glycol, Dipropylene glycol, Tripropylene glycol, other poly(propylene glycol), and/or the mono-alkoxy derivatives of the above polyethers.
g) Simple alcohols such as methanol, ethanol, propanol and the like.
h) Simple alkylamines such as methylamine, ethylamine, propylamine, butylamine and the like

Combinations of the substituent linking atom and the bridging linking atom for a given s-triazine ring which are preferred are NO, OO and ON, with NN being less preferred.

For —O— linked bridging groups, the linkage may be made, for example, through an etheric oxygen in the polyoxyalkylene chain. If the bridging group is to be —NH— linked to the triazine, then linking groups (L1, L2) will be present.

In use, the compositions of the invention are applied to cellulosic textiles, preferably cotton textiles, and cured by heat treatment.

Accordingly a further aspect of the present invention subsists in a method of the treatment of cellulosic textiles which comprises the steps of:
a) applying to the textile a composition comprising a textile compatible carrier, an acid binding agent and a cellulose cross linking agent which is water soluble or soluble in a water miscible solvent in which the cellulose cross-linking agent comprises two or more mono-reactive s-triazine moieties bridged by a flexible bridging moiety, said bridging moiety comprising at least one aliphatic polyoxyalkylene chain and wherein each s-triazine moiety is provided with a hydrophilic or a non-hydrophilic substituent group and,
b) heating the textile so as to cause a reaction between the said composition and the textile.

The application step (a) can be performed by soaking, padding or spraying, preferably by spraying.

Application from aqueous solution is preferred, as are water soluble molecules of the general type described above. However, it is possible to employ molecules which are water insoluble per se, but are soluble in a water-miscible solvent.

A subsidiary aspect of the present invention comprises the combination of a composition as claimed herein and means for spraying said composition. Preferably the composition is sprayed as a component of an at least partly aqueous spray.

Suitable heat treatment as in step (b) may be applied with an iron, a steam press or an equivalent heating and pressing means. Ironing is preferred. Ironing and spraying means can be combined into a single unit by use of an iron such as the ‘Perfective’™ iron manufactured by Philips. The preferred temperature range for heat-treatment is 50-250 Celsius, preferably 90-180 Celcius.

### DETAILED DESCRIPTION OF THE INVENTION

Various preferred and/or optional features of the product and method aspects of the present invention are described in further detail below.

Preferred Cross Linking Agents:

Especially preferred cross-linking agents include molecules of the formula (2a, 2b) below: 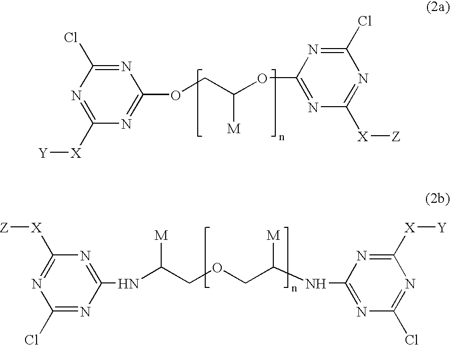
Wherein:

n is 1-10, preferably 1-7

M is independently H or methyl

X is independently S, O or NH

Y and Z are independently cellulose-unreactive substituents.

For compositions in which the cross linker is of type [2a], n is preferably 2-4 and M is H. It is also preferable that X is —NH— and Y and Z are independently selected from the group comprising: —CH₂—CH₂—SO₃⁻, —CH₂—COO⁻, and —CH₂—CH₂—CH₃.

For compositions in which the cross linker is of type [2b], n is preferably 2-7 and M is H or methyl. It is also preferable that X is —O— and Y and Z are independently selected from the group comprising: —CH₃, —CH₂—COO⁻ and —CH₂—CH₂—CH₃.

Particularly preferred cross-linkers are: 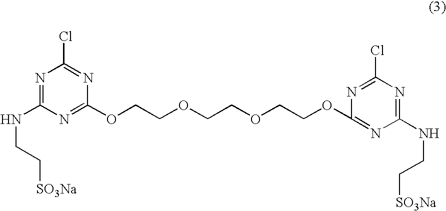
(3) is a taurine Derivative of 1,8-Bis-(4,6-dichloro-[1,3,5]triazin-2-yloxy)-3,6-diox-octane. 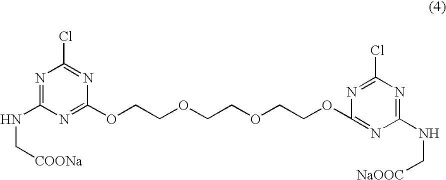
(4) is a glycine Derivative of 1,8-Bis-(4,6-dichloro-[1,3,5]triazin-2-yloxy)-3,6-diox-octane 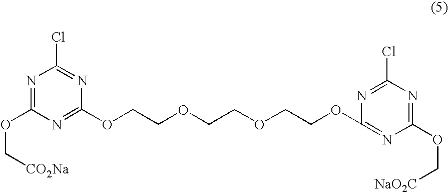
(5) is a glycolic Acid Derivative of 1,8-Bis-(4,6-dichloro-[1,3,5]triazin-2-yloxy)-3,6-diox-octane 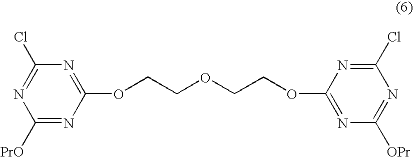
(6) is bis-(2-chloro-4-propoxy-triazine)-6-diethyleneglycol 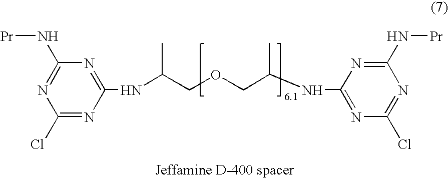
(7) is 2,2′-[D400]Polyoxypropylenediaminobis[4-chloro-6-propylamino-s-triazine] 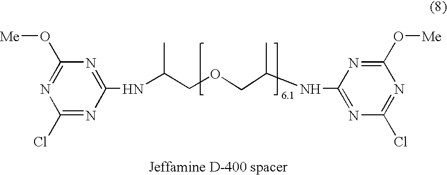
(8) is 2,2′-[D400]Polyoxypropylenediaminobis[4-chloro-6-methoxy-S-triazine] 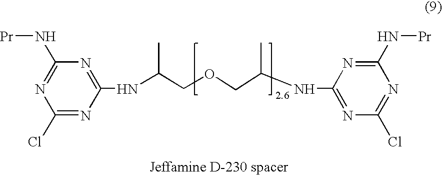
(9) is 2,2′-[D230]Polyoxypropylenediaminobis[4-chloro-6-propylamino-S-triazine]. 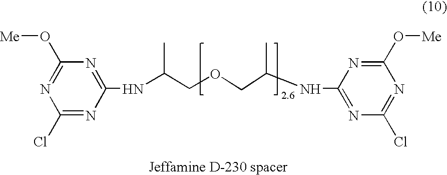
(10) is 2,2′-[D230]Polyoxypropylenediaminobis[4-chloro-6-methoxy-S-triazine] 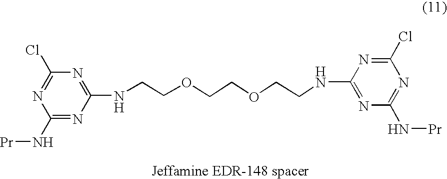
(11) is 2,2′-Triethyleneglycoldiaminobis[4-chloro-6-propylamino-S-triazine] 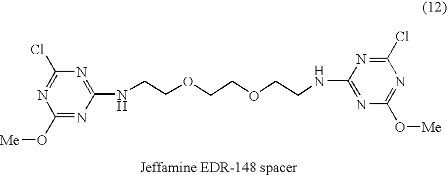
(12) is 2,2′-Triethyleneglycoldiaminobis[4-chloro-6-methoxy-S-triazine. 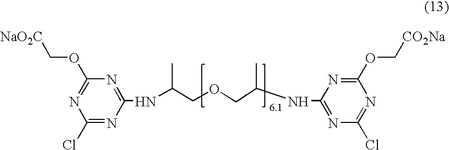
(13) is mono-chloro sodium glycolate triazine derivative of Jeffamine D-400

Carriers and Product Form:

The compositions of the invention will generally comprise a textile compatible carrier.

In the context of the present invention the term “textile compatible carrier” includes a component which can assist in the interaction of the cellulose cross-liking agent with a textile. The carrier can be a simply a solvent for the cross-linking agent, although the carrier can also provide benefits in addition to those provided by the cross-linking agent e.g. softening, cleaning etc. Preferably, the carrier is a detergent-active compound or a textile softener or conditioning compound or a detergent.

In a washing process, as part of a conventional textile washing product, such as a detergent composition, the textile-compatible carrier will typically be a detergent-active compound. Whereas, if the textile treatment product is a rinse conditioner, the textile-compatible carrier will be a textile softening and/or conditioning compound. These are described in further detail below.

The cross-linking agent can be used to treat the textile in the wash cycle of a laundering process. The cross-linking agent can also be used in the rinse cycle, or, preferably applied prior to or during ironing and/or pressing.

The composition of the invention may be in the form of a liquid, solid (e.g. powder or tablet), a gel or paste, spray, stick or a foam or mousse. Examples include a soaking product, a rinse treatment (e.g. conditioner or finisher) or a main-wash product. As noted above, spray products are particularly suited to application as part of an ironing or pressing process.

Liquid compositions may also include an agent which produces a pearlescent appearance, e.g. an organic pearlising compound such as ethylene glycol distearate, or inorganic pearlising pigments such as microfine mica or titanium dioxide (TiO₂) coated mica. Liquid compositions may be in the form of emulsions or emulsion precursors thereof.

Detergent Active Compounds:

If the composition of the present invention is itself in the form of a detergent composition, the textile-compatible carrier may be chosen from soap and non-soap anionic, cationic, nonionic, amphoteric and zwitterionic detergent active compounds, and mixtures thereof.

Many suitable detergent active compounds are available and are fully described in the literature, for example, in “Surface-Active Agents and Detergents”, Volumes I and II, by Schwartz, Perry and Berch.

The preferred textile-compatible carriers that can be used are soaps and synthetic non-soap anionic and nonionic compounds.

Anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Cationic surfactants that may be used include quaternary ammonium salts of the general formula R₁R₂R₃R₄N⁺ X⁻ wherein the R groups are independently hydrocarbyl chains of C₁-C₂₂ length, typically alkyl, hydroxyalkyl or ethoxylated alkyl groups, and X is a solubilising cation (for example, compounds in which R₁ is a C₈-C₂₂ alkyl group, preferably a C₈-C₁₀or C₁₂-C₁₄ alkyl group, R₂ is a methyl group, and R₃ and R₄, which may be the same or different, are methyl or hydroxyethyl groups); and cationic esters (for example, choline esters) and pyridinium salts.

The total quantity of detergent surfactant in the composition is suitably from 0.1 to 60 wt % e.g. 0.5-55 wt %, such as 5-50 wt %.

Preferably, the quantity of anionic surfactant (when present) is in the range of from 1 to 50% by weight of the total composition. More preferably, the quantity of anionic surfactant is in the range of from 3 to 35% by weight, e.g. 5 to 30% by weight.

Preferably, the quantity of nonionic surfactant when present is in the range of from 2 to 25% by weight, more preferably from 5 to 20% by weight.

Amphoteric surfactants may also be used, for example amine oxides or betaines.

Builders:

The compositions may suitably contain from 10 to 70%, preferably from 15 to 70% by weight, of detergency builder. Preferably, the quantity of builder is in the range of from 15 to 50% by weight.

The detergent composition may contain as builder a crystalline aluminosilicate, preferably an alkali metal aluminosilicate, more preferably a sodium aluminosilicate.

The aluminosilicate may generally be incorporated in amounts of from 10 to 70% by weight (anhydrous basis), preferably from 25 to 50%. Aluminosilicates are materials having the general formula:
0.8-1.5 M₂O.Al₂O₃.0.8-6 SiO₂
where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature.

Alternatively, or additionally to the aluminosilicate builders, phosphate builders may be used.

Textile Softening and/or Conditioner Compounds:

If the composition of the present invention is in the form of a textile conditioner composition, the textile-compatible carrier will be a textile softening and/or conditioning compound (hereinafter referred to as “textile softening compound”), which may be a cationic or nonionic compound.

The softening and/or conditioning compounds may be water insoluble quaternary ammonium compounds. The compounds may be present in amounts of up to 8% by weight (based on the total amount of the composition) in which case the compositions are considered dilute, or at levels from 8% to about 50% by weight, in which case the compositions are considered concentrates.

Compositions suitable for delivery during the rinse cycle may also be delivered to the textile in the tumble dryer if used in a suitable form. Thus, another product form is a composition (for example, a paste) suitable for coating onto, and delivery from, a substrate e.g. a flexible sheet or sponge or a suitable dispenser during a tumble dryer cycle.

Suitable cationic textile softening compounds are substantially water-insoluble quaternary ammonium materials comprising a single alkyl or alkenyl long chain having an average chain length greater than or equal to C₂₀. More preferably, softening compounds comprise a polar head group and two alkyl or alkenyl chains having an average chain length greater than or equal to C₁₄. Preferably the textile softening compounds have two, long-chain, alkyl or alkenyl chains each having an average chain length greater than or equal to C₁₆.

Most preferably at least 50% of the long chain alkyl or alkenyl groups have a chain length of C₁₈ or above. It is preferred if the long chain alkyl or alkenyl groups of the textile softening compound are predominantly linear.

Quaternary ammonium compounds having two long-chain aliphatic groups, for example, distearyldimethyl ammonium chloride and di(hardened tallow alkyl) dimethyl ammonium chloride, are widely used in commercially available rinse conditioner compositions. Other examples of these cationic compounds are to be found in “Surface-Active Agents and Detergents”, Volumes I and II, by Schwartz, Perry and Berch. Any of the conventional types of such compounds may be used in the compositions of the present invention.

The textile softening compounds are preferably compounds that provide excellent softening, and are characterised by a chain melting Lβ to Lα transition temperature greater than 25° C., preferably greater than 35° C., most preferably greater than 45° C. This Lβ to Lα transition can be measured by DSC as defined in “Handbook of Lipid Bilayers”, D Marsh, CRC Press, Boca Raton, Fla., 1990 (pages 137 and 337).

Substantially water-insoluble textile softening compounds are defined as textile softening compounds having a solubility of less than 1×10⁻³ wt % in demineralised water at 20° C. Preferably the textile softening compounds have a solubility of less than 1×10⁻⁴ wt %, more preferably less than 1×10⁻⁸ to 1×10⁻⁴ wt %.

Especially preferred are cationic textile softening compounds that are water-insoluble quaternary ammonium materials having two C₁₂₋₂₂ alkyl or alkenyl groups connected to the molecule via at least one ester link, preferably two ester links. Di(tallowoxyloxyethyl) dimethyl ammonium chloride and/or its hardened tallow analogue are especially preferred of the compounds of this type. Other preferred materials include 1,2-bis(hardened tallowoyloxy)-3-trimethylammonium propane chloride. Their methods of preparation are, for example, described in U.S. Pat. No. 4,137,180 (Lever Brothers Co). Preferably these materials comprise small amounts of the corresponding monoester as described in U.S. Pat. No. 4,137,180, for example, 1-hardened tallowoyloxy-2-hydroxy-3-trimethylammonium propane chloride.

Other useful cationic softening agents are alkyl pyridinium salts and substituted imidazoline species. Also useful are primary, secondary and tertiary amines and the condensation products of fatty acids with alkylpolyamines.

The compositions may alternatively or additionally contain water-soluble cationic textile softeners, as described in GB 2 039 556B (Unilever).

The compositions may comprise a cationic textile softening compound and an oil, for example as disclosed in EP-A-0829531.

The compositions may alternatively or additionally contain nonionic textile softening agents such as lanolin and derivatives thereof.

Lecithins are also suitable softening compounds.

Nonionic softeners include Lβ phase forming sugar esters (as described in M Hato et al Langmuir 12, 1659, 1666, (1996)) and related materials such as glycerol monostearate or sorbitan esters. Often these materials are used in conjunction with cationic materials to assist deposition (see, for example, GB 2 202 244). Silicones are used in a similar way as a co-softener with a cationic softener in rinse treatments (see, for example, GB 1 549 180).

The compositions may also suitably contain a nonionic stabilising agent. Suitable nonionic stabilising agents are linear C₈ to C₂₂ alcohols alkoxylated with 10 to 20 moles of alkylene oxide, C₁₀ to C₂₀ alcohols, or mixtures thereof.

Advantageously the nonionic stabilising agent is a linear C₈ to C₂₂ alcohol alkoxylated with 10 to 20 moles of alkylene oxide. Preferably, the level of nonionic stabiliser is within the range from 0.1 to 10% by weight, more preferably from 0.5 to 5% by weight, most preferably from 1 to 4% by weight. The mole ratio of the quaternary ammonium compound and/or other cationic softening agent to the nonionic stabilising agent is suitably within the range from 40:1 to about 1:1, preferably within the range from 18:1 to about 3:1.

The composition can also contain fatty acids, for example C₈ to C₂₄ alkyl or alkenyl monocarboxylic acids or polymers thereof. Preferably saturated fatty acids are used, in particular, hardened tallow C₁₆ to C₁₈ fatty acids. Preferably the fatty acid is non-saponified, more preferably the fatty acid is free, for example oleic acid, lauric acid or tallow fatty acid. The level of fatty acid material is preferably more than 0.1% by weight, more preferably more than 0.2% by weight. Concentrated compositions may comprise from 0.5 to 20% by weight of fatty acid, more preferably 1% to 10% by weight. The weight ratio of quaternary ammonium material or other cationic softening agent to fatty acid material is preferably from 10:1 to 1:10.

In an industrial treatment process, the concentration of cross-linking agent used in the treating solution may be in the range of 0.01% to 20% by weight depending on the solubility of the cross-linking agent and the degree of cellulose crosslinking required. It is desirable if the level of cross-linking agent is from 0.1% to 20% of the total composition, preferably from 1% to 20%.

If the composition is to be used in a laundry process as part of a conventional fabric treatment product, such as a rinse conditioner or main wash product, it is preferable if the level of cross-linking agent is from 0.01% to 10%, more preferably 0.05% to 7.5%, most preferably 0.1 to 5 wt % of the total composition.

If, however, the composition is to be used in a laundry process as a product to specifically treat the fabric to reduce creasing, higher levels of cross-linking agent can be used. Preferred amounts are from 0.01% to 15%, more preferably 0.05% to 10%, for example from 0.1 to 7.5 wt % of the total composition.

If the composition is to be used in a spray product it is preferred that the level of cross-linking agent is from 0.5 to 20 wt %, preferably 1 to 20 wt % of the total composition.

The level of acid binding agent is selected with the level of cross-linking agent and the alkaline reserve of the acid binding agent in mind. Given that the cross-linking agent releases two moles of acid for each mole of reaction the acid binding agent should be present in such a quantity as to adsorb this acid.

Other Components

Compositions according to the invention may comprise soil release polymers such as block copolymers of polyethylene oxide and terephthalate.

Other optional ingredients include emulsifiers, electrolytes (for example, sodium chloride or calcium chloride) preferably in the range from 0.01 to 5% by weight, pH buffering agents, and perfumes (preferably from 0.1 to 5% by weight).

Further optional ingredients include non-aqueous solvents, fluorescers, colourants, hydrotropes, antifoaming agents, enzymes, optical brightening agents, and opacifiers.

Suitable bleaches include peroxygen bleaches. Inorganic peroxygen bleaching agents, such as perborates and percarbonates are preferably combined with bleach activators. Where inorganic peroxygen bleaching agents are present the nonanoyloxybenzene sulphonate (NOBS) and tetra-acetyl ethylene diamine (TAED) activators are typical and preferred.

Suitable enzymes include proteases, amylases, lipases, cellulases, peroxidases and mixtures thereof.

In addition, compositions may comprise one or more of anti-shrinking agents, anti-wrinkle agents, anti-spotting agents, germicides, fungicides, anti-oxidants, UV absorbers (sunscreens), heavy metal sequestrants, chlorine scavengers, dye fixatives, anti-corrosion agents, drape imparting agents, antistatic agents and ironing aids. The lists of optional components are not intended to be exhaustive.

Lubricants and other ‘wrinkle release’ agents are a particularly preferred optional component of compositions according to the invention. These are believed to work together with the cross-linking agent to restore textiles towards a wrinkle-free state after wrinkling. They are believed to function by reducing fibre-fibre friction and therefore facilitate recovery of the flat state. Without wishing to limit the invention by any theory of operation it is believe that the combination of the ‘springy’ linker group of the triazines and the presence of a lubricant is particularly effective in preventing or removing wrinkles.

Preferred Lubricants:

Preferred lubricants include hydroxyl containing polymers and amine/amino containing polymers. Alternative lubricants include various fatty and oily materials, including triglycerides, sugar esters and mineral oils.

Particularly preferred optional components are hydroxyl-containing polymer, preferably helical hydroxyl-containing polymers. Fabric care compositions comprising a cross-linker and a hydroxyl containing polymer are defined in our UK patent application no. 0219281.3.

The hydroxyl-containing polymers are preferably polymers which contain a plurality of hydroxyl groups, but no silicon atoms. Preferably, the hydroxyl-containing polymer is a polymeric polyol or a polypeptide. Examples of polymeric polyols suitable for practising the invention include polysaccharides such as starch, sugar, cellulose, amylopectin, glycogen, poly(vinyl alcohol), poly(allyl alcohol), and the like.

It is preferred that the hydroxyl-containing polymer is selected from the group consisting of poly(alkenyl alcohols), polysaccharides, polypeptides, hydroxyalkyl-substituted nylons, and derivatives thereof. Examples of suitable polypeptides include collagen, elastin, gelatin, soy protein, polyaspartic acid, casein, poly α-benzyl glutamate, polyglutamic acid, and poly α-lysine.

More preferably, the hydroxyl-containing polymer is a poly(alkenyl alcohol), a polysaccharide or a derivative thereof. The “alkenyl” group in such compounds may be a branched or unbranched unsaturated hydrocarbon containing 1 to 12, preferably 1 to 6 and especially 1 to 4 carbon atoms. The alkenyl group may also be substituted. However, it is preferred that the alkenyl group is unsubstituted. Preferably, alkenyl groups are unbranched.

It is particularly preferred that the poly(alkenyl alcohol) is poly(vinyl alcohol) or poly(allyl alcohol), with poly(vinyl alcohol) being especially preferred. If poly(vinyl alcohol) is used, it is preferred that this has a molecular weight of 3,000 to 50,000, more preferably 3,000 to 20,000.

As used herein, the term “polysaccharides” includes natural polysaccharides, synthetic polysaccharides, polysaccharide derivatives and modified polysaccharides. Suitable polysaccharides for use in preparing the compounds of the present invention include, but are not limited to, gums, arabinans, galactans, seeds and mixtures thereof as well as cellulose and derivatives thereof.

It is desirable that the polysaccharides utilised in the present invention have a molecular weight in the range of from about 10,000 to about 10,000,000, more preferably from about 10,000 to about 1,000,000, most preferably from about 10,000 to about 500,000. It is preferred that polysaccharides of low viscosity are used, especially those having a molecular weight of 10,000 to 50,000.

It is especially preferred that the polysaccharide is amylose, starch, amylopectin, guar gum, xanthan gum, tamarind xyloglucan, carrageenan or a derivative thereof. Of these, carrageenan is particularly preferred.

Further, the cross-linker may be used in a fabric care composition which further comprises an amine-containing polymer, as defined in our UK patent application no. 0225292.2. The amine containing polymer may be any suitable polymer which contains a plurality of amine groups. Preferably, the amine-containing polymer is an amine-containing silicone polymer, an aminosilicone.

An aminosilicone is any organosilicone having an amine functionality. The amine functionality may be either on the side chain of the organosilicone or on the chain terminus. Preferably, the amine is a primary amine. However, any amine which is capable of reacting with the crosslinking agent is included. Aminosilicones employed in the present compositions may be linear, branched or partially crosslinked.

Additionally, the cross-linker may be used in a fabric care composition which further comprises a silicone-containing compound, such as a silicone carboxylates or any silicone compound containing a hydroxy or silanol group e.g. hydroxysilicone, as defined in WO 01/44426.

Thermoplastic Elastomers:

In a fabric care composition which includes a cross-linker according to the present invention, a thermoplastic elastomer may also be present. It is envisaged that these compounds would form an elastomeric scaffold around the fibres and facilitate recovery of the flat state.

Such a thermoplastic elastomer is preferably a block copolymer comprising a core polymer and two or more flanking polymers, each flanking polymer being covalently bound to an end of the core polymer. Preferably, the backbone of the core polymer comprises at least a proportion of C—C (i.e. carbon-carbon) bonds and/or Si—O (ie. silicon—oxygen) bonds and two or more flanking polymers. The linkages in the backbone of the core polymer preferably comprise greater than 30%, more preferably greater than 50, even more preferably greater than 75%, most preferably greater than 95%, such as, for example, at least 99% (these percentages being by number) C—C and/or Si—O bonds. In some cases, the backbone may contain 100% (by number) C—C and/or Si—O bonds. Other bonds which may be present in the backbone of the core polymer, in addition to the C—C and/or Si—O bonds, include, for example, C—O bonds. The flanking polymers are bound to an end of the core polymer. Preferably, the flanking polymers comprise at least a proportion of C—C (i.e., carbon-carbon) bonds. The linkages in the backbone of the flanking polymer preferably comprise greater than 50%, more preferably greater than 75%, most preferably greater then 95%, such as, for example, at least 99% (these percentages being by number) C—C bonds. In some cases, the backbone of the flanking polymer may contain 100% (by number) C—C bonds. Other bonds which may be present in the backbone of the flanking polymer, in addition to the C—C bonds, include, for example, C—O and C—N bonds.

In order that the invention may be further and better understood it will be described below with reference to several non-limiting examples.

### EXAMPLES

### SYNTHESIS EXAMPLES

### Example 1

### 1,8-Bis-(4,6-dichloro-[1,3,5]triazin-2-yloxy)-3,6-diox-octane [E1]

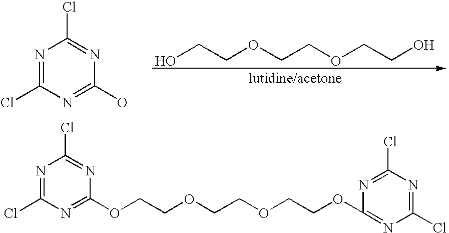

To a solution of cyanuric chloride (20.05 g, 109 mmol) in 140 ml acetone a solution of triethylene glycol (7.77 g, 52 mmol) and 2,6-lutidine (11.25 g, 105 mmol) in 50 ml acetone was added dropwise at 0° C. After addition, the reaction mixture was kept stirring at 0° C. for 2 hr. The resulting mixture was warmed to room temperature overnight, filtrated, and the filtrate was de-coloured with charcoal. After removal of acetone, the residue was purified by column chromatography (eluate: CH₂Cl₂) to give a viscous liquid [E1] (11.3 g , 47%); ¹HNMR (300 MHz, δ, ppm, CDCl₃) 3.68 (s, 4H), 3.86 (t, 4 H), 4.64 (t, 4H); MS-ESI 445 (M+H⁺), 464 (M+NH₄⁺).

### Example 2

### Taurine Derivative of 1,8-Bis-(4,6-dichloro-[1,3,5]triazin-2-yloxy)-3,6-diox-octane [E2]

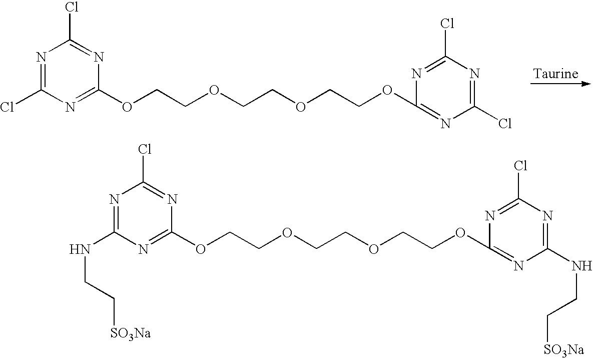

To a 250 ml flask containing 1,8-bis-(4,6-dichloro-[1,3,5]triazin-2-yloxy)-3,6-diox-octane [E1] (7.0 g, 15.7 mmol) and THF (30 ml) was added a solution of taurine (3.9 g, 31.4 mmol) and sodium carbonate (3.33 g, 31.4 mmol) in 60 ml water at 0° C. After addition, the mixture was kept stirring overnight at room temperature. After removal of THF and water, the residue was washed by acetone to give a white solid [E2] (10.6 g, quantity); ¹H NMR (300 MHz, δ, ppm, D₂O) 3.14˜3.2 (m, 4H), 3.75˜3.80 (m, 8H), 3.87˜3.90 (m, 4H), 4.42˜4.53 (m, 4H); MS-ESI 623 (M−2Na⁺+3H⁺), 645 (M−Na⁺+2H⁺), 667 (M+1), 689 (M+Na⁺)

### Example 3

### Synthesis of Glycine Derivative of 1,8-Bis-(4,6-dichloro-[1,3,5]triazin-2-yloxy)-3,6-diox-octane [E3]

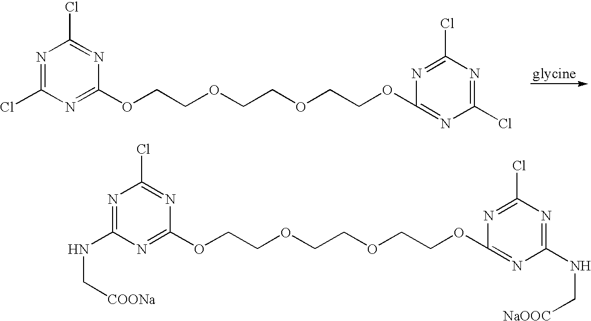

To a 250 ml flask containing 1,8-bis-(4,6-dichloro-[1,3,5]triazin-2-yloxy)-3,6-diox-octane [E1] (8.0 g, 17.9 mmol) and THF (40 ml) was added dropwise a solution of glycine (2.69 g, 35.9 mmol) and sodium carbonate (3.8 g, 35.9 mmol) in 60 ml water at 0° C. After addition, the mixture was kept stirring overnight at room temperature. After removal of THF and water, the residue was washed by acetone to give a slight yellow solid [E3] (10.4 g, quantity); ¹H NMR (300 MHz, δ, ppm, D₂O) 3.74 (s, 4H), 3.84˜3.87 (m, 4H), 3.90 (s, 4H), 4.45˜4.48 (m, 4H); MS-ESI 523 (M−2Na⁺+3H⁺)

### Example 4

### Synthesis of Glycolic Acid Derivative of 1,8-Bis-(4,6-dichloro-[1,3,5]triazin-2-yloxy)-3,6-diox-octane[E4]

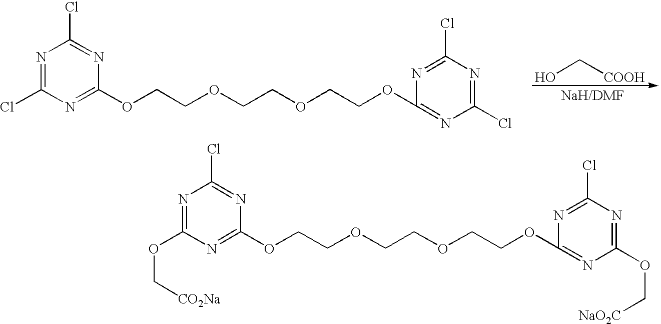

To a 250 ml dry flask containing sodium hydride (2.82 g , 60% in mineral oil, 70.6 mmol) and 30 ml DMF was added dropwise a solution of glycolic acid (2.68 g, 35.3 mmol) in 10 ml DMF at 0° C. After addition, the mixture was kept stirring for 2 hr at room temperature, then cooled by ice bath. 1,8-bis-(4,6-dichloro-[1,3,5]triazin-2-yloxy)-3,6-diox-octane [E1] (7.87 g, 17.65 mmol) in 20 ml DMF was added dropwise. After addition, the reaction mixture was kept stirring at room temperature overnight, then quenched by water. After distilled off the DMF in vacuum, the residue was washed by acetone to give a slight yellow solid [E4] (10.2 g, quantity); ¹H NMR (300 MHz, δ, ppm, DMSO-d₆) 3.54 (s, 4H), 3.64 (t, 4H), 4.20 (t, 4H), 4.91 (s, 4H); MS-ESI 409 (M−2CH₂COONa+3H⁺), 409 (M−2CH₂COONa+2H+Na⁺).

### Example 5

### Synthesis of Bis-(2,4-dichloro-triazine)-6-diethyleneglycol [E5]

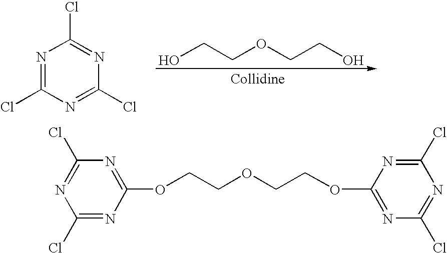

Cyanuric Chloride (21.6 g, 0.117 M) is dissolved in 250 ml of acetone and cooled with stirring in an ice-salt bath under a blanket of N₂. Diethylene glycol (6.2 g, 0.0585 M) and collidine (14.2 g, 0.117 M) in 80 ml of acetone is added slowly dropwise with stirring at a temperature of 0° C. to 5° C. The reaction mixture is stirred at 0 to 5° C. for 2 hours and then allowed to warm to room temperature slowly and left stirring for a further 12 hours (a white precipitate of collidine HCl in a yellow solution is observed). The collidine hydrochloride is filtered off, washed with acetone (150 ml) and the filtrate evaporated to dryness to yield a crude orange solid (fraction 1), 26 g (100%). A sample of the crude product (10 g) is recrystallised from petroleum ether (80-110° C.) to yield a crude yellow solid (fraction 2), 7.5 g (75% yield). A sample of the crude yellow solid, (5.38 g) is decolourised with acetone/charcoal at room temperature to yield the product as a white solid [E5], 4.64 g (64.5% yield).

### Example 6

### Synthesis of Bis-(2-chloro-4-propoxy-triazine)-6-diethyleneglycol [E6]

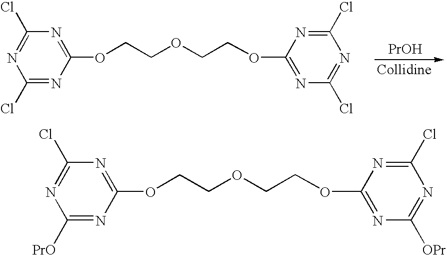

Bis-(2,4-dichloro-triazine)-6-diethyleneglycol [E5] (5 g, 0.0124 M), collidine (3 g, 0.0248 M) and propan-1-ol (1.49 g, 0.0248 M) were placed into a 50 ml round bottom flask fitted with a condenser. The reaction mixture was heated to 100° C. for 2 hours, cooled and acetone added (40 ml). The resultant white precipitate was filtered off and the dark orange filtrate decolourised twice at room temperature with charcoal. The orange solution was evaporated to dryness to yield an orange oil [E6] (4.87 g, 87% yield).

### Example 7

### Synthesis of 4,6-Dichloro-N-methyl-1,3,5-triazin-2-amine [E7]

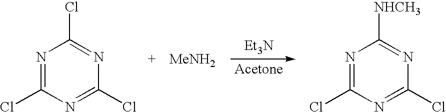

Cyanuric chloride (9.5 g, 0.052 M) was placed into a 3 necked 500 ml round bottom flask fitted with a thermometer, pressure equalising dropping funnel and stirrer bar. Acetone (150 ml) was added and the cyanuric chloride dissolved with stirring at room temperature to give a clear colourless solution followed by cooling in an ice/salt bath to 0° C. To this solution was added a mixture of methylamine (40% soln, 4.65 ml, 0.052 M) and triethylamine (5.5 g, 0.052 M) via a dropping funnel over a period of 30 minutes with stirring. The temperature of the reaction mixture was maintained between 0-5° C. during the addition (on addition a turbid yellow reaction mixture was observed). On complete addition the ice bath was removed and stirring continued for a further 3 hours. The reaction mixture was transferred to a rotary evaporator flask and the acetone removed under reduced pressure. The Reaction mixture was dissolved in ethylacetate, washed with dilute HCl to remove triethylamine and further washed with water (2×100 ml), 5% sodium bicarbonate solution (1×50 ml), water (2×100 ml), saturated sodium chloride solution (1×50 ml), dried over magnesium sulphate, filtered and the filtrate evaporated to yield a pale yellow solid [E7] (3.9 g, 50% yield).

### Example 8

### Synthesis of 2,2′-[D400]Polyoxypropylene-diaminobis[4,6-dichloro-s-triazine] [E8]

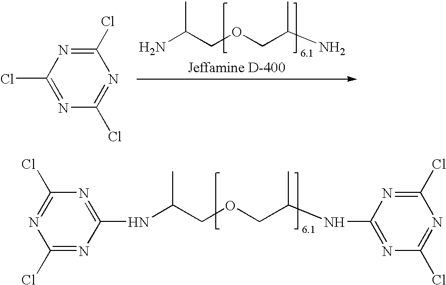

Cyanuric chloride (10.29 g, 0.0558 M) is dissolved in tetrahydrofuran (THF, 120-150 ml) and cooled to −5° C. to 0° C. in an ice/acetone bath. Jeffamine D-400 (11.6 g, 0.0279 M) in 30 ml of water is added slowly dropwise with stirring at a temperature of −5° C. to 0° C. (during addition the reaction mixture has a slightly milky appearance). Sodium hydroxide (2.5 g, 0.0625 M) in 20 ml water is added slowly dropwise with stirring at a temperature of −5° C. to 5° C. (on complete addition the reaction mixture has a milky appearance). The reaction mixture is allowed to warm to room temperature (18-20° C.) with stirring (1 hour). THF is removed under reduced pressure to leave a white oily/water mixture. This is dissolved in chloroform (200 ml) and washed with water (3×100 ml), brine (2×50 ml), dried over magnesium sulphate, filtered and evaporated to dryness to yield a clear pale yellow viscous oil [E8] (18.3 g, 94% yield).

### Example 9

### Synthesis of 2,2′-[D400]Polyoxypropylene-diaminobis[4-chloro-6-propylamino-s-triazine] [E9]

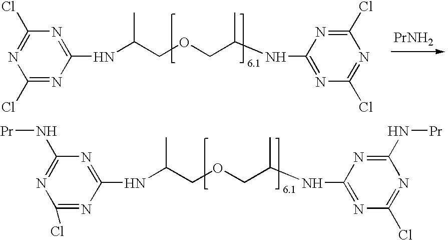

2,2′-[D400]Polyoxypropylenediaminobis[4,6-dichloro-s-triazine] [E8] (2.85 g, 4.1 mM) is dissolved in acetone (75 ml) and warmed to 30-35° C. Propylamine (0.48 g, 8.2 mM) is added directly to give a clear pale yellow reaction mixture. Sodium hydroxide (0.33 g, 8.25 mM) in 5 ml water is added dropwise over 5 min. with stirring (a turbid reaction mixture is observed). The turbid reaction mixture is then stirred at 35° C. for 1 hour followed by a further hour at 60-70° C. Acetone is removed under reduced pressure to yield an oil/water reaction mixture. This is dissolved in dichloromethane (100 ml) and washed with water (3×30 ml), brine (2×20 ml), dried over magnesium sulphate, filtered and evaporated to dryness to yield a clear very pale yellow viscous oil [E9] (2.54 g, 84% yield).

### Example 10

### Synthesis of 2-Methoxy[4,6-dichloro-S-triazine] [E10]

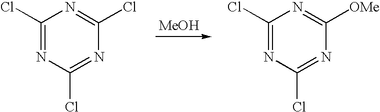

Sodium bicarbonate (33.6 g, 400 mmol) and cyanuric chloride (36.8 g, 200 mmol) were added to a mixture of water (25 ml) and methanol (200 ml). The reaction mixture was stirred vigorously for 30 mins at 30° C. After which time heating was stopped and water (200 ml) added to the reaction mixture. The precipitate formed was filtered off and washed with water to yield the product [E10] as a white solid (30.3 g, 84%). Purity of the product was good but a small sample was sublimed for analysis.

The structure of the product was confirmed by FAB mass spectroscopy M+H (2×Cl isotope pattern). δ_{H} (500 MHz; CDCl₃); 4.14 (s, 3H, OCH₃); δ_{c} (125 MHz; CDCl₃) 172.61, 171.54, 56.97.

### Example 11

### Synthesis of 2,2′-[D400]Polyoxypropylene-diaminobis[4-chloro-6-methoxy-S-triazine] [E11]

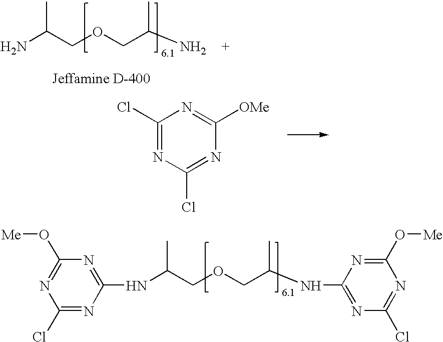

A solution of 2-methoxy[4,6-dichloro-S-triazine] [E10] (5.0 g, 27 mmol) in acetone (150 ml) was added dropwise with stirring to Jeffamine D400 (5.6 g, 13.9 mmol) and sodium hydrogen carbonate (2.32 g, 30 mmol) in acetone (100 ml) and water (250 ml). The reaction mixture was stirred at room temperature for a further 2 hours. The solvents were removed in vacuo and the crude product extracted with chloroform/water. The organic fraction was dried and evaporated to yield the product [E11] as a colourless oil (8.7 g, 91%).

δ_{H} (500 MHz; CDCl₃); 4.3-4.2 (brm, 2H, NHCH(CH₃)CH₂OCH₂), 3.98-3.93 (s, 6H, OCH₃), 3.65-3.35 (brm, 22H, NHCH(CH₃)CH₂OCH₂CH(CH₃), 1.26 (brs, 6H, NHCH(CH₃)CH ₂OCH₂), 1.12 (brs, 18H, NHCH(CH₃)CH₂OCH₂CH(CH₃);

### Example 12

### Synthesis of 2,2′-[D230]Polyoxypropylene-diaminobis[4,6-dichloro-S-triazine] [E12]

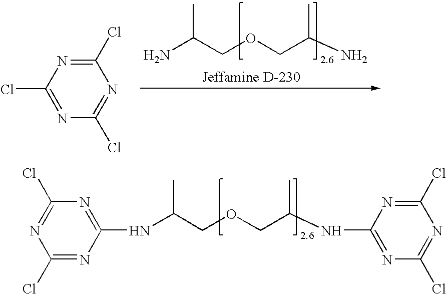

A solution of Jeffamine D230 (23 g, 100 mmol) and sodium hydroxide (8.8 g, 220 mmol) in water (70 ml) was added dropwise with stirring, over two hours at 0° C. to a solution of cyanuric chloride (36.9 g, 200 mmol) in THF (400 ml). The reaction temperature was maintained below 5° C. during the addition. The reaction mixture was then allowed to warm slowly to room temperature and stirred for a further hour. The reaction mixture was evaporated in vacuo. The colourless oil was dissolved in dichloromethane washed and dried (MgSO₄) to yield the product [E12] as a colourless viscous oil (42.1 g, 80%).

δ_{H} (500 MHz; CDCl₃); 4.25 (brm, 2H, NHCH(CH₃)CH₂OCH₂), 3.4-3.6 (brm, 10H, NHCH(CH₃)CH₂OCH₂CH(CH₃), 1.26 (brs, 6H, NHCH(CH₃)CH₂OCH₂), 1.11 (brs, 6H, NHCH(CH₃)CH₂OCH₂CH(CH₃);

### Example 13

### Synthesis of 2,2′-[D230]Polyoxypropylene-diaminobis[4-chloro-6-propylamino-S-triazine] [E13]

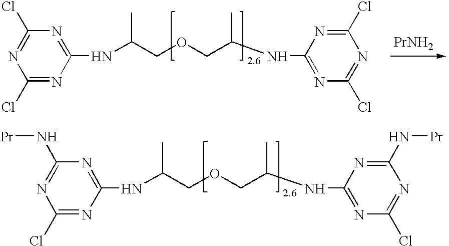

A solution of bis(triazine) [E12] (9.21 g, 17.5 mmol) in acetone (75 ml) was added to a vigorously stirred solution of propylamine (2.06 g, 35 mmol) and sodium hydroxide (1.4 g, 35 mmol) in water (10 ml) and acetone (75 ml). The reaction mixture was heated to 45° C. for 1 hour. The solvents were removed by rotary evaporation to yield a yellow oil. This was dissolved in dichloromethane washed with water and dried (MgSO₄). After evaporation the product [E13] was obtained as a pale yellow oil (4.8 g, 91%). δ_{H} (500 MHz; CDCl₃); 4.25 (brm, 2H, NHCH(CH₃)CH₂OCH₂), 3.3-3.7 (brm, 12H, NHCH(CH₃)CH₂OCH₂CH(CH₃) plus NHCH₂CH₂CH₃), 1.55 (br, 4H, NHCH₂CH₂CH₃), 1.20 (brs, 6H, NHCH(CH₃)CH₂OCH₂), 1.13 (brs, 6H, NHCH(CH₃)CH₂OCH₂CH(CH₃), 0.92 (br, 6H, NHCH₂CH₂CH₃);

### Example 14

### Synthesis of 2,2′-[D230]Polyoxypropylene-diaminobis[4-chloro-6-methoxy-S-triazine] [E14]

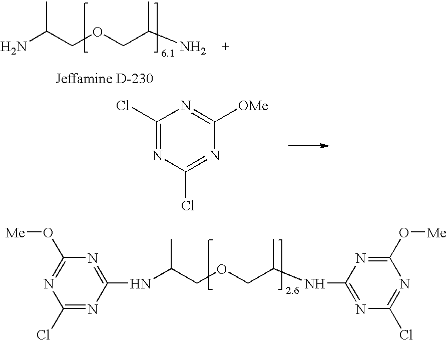

Jeffamine D230 (3.19 g, 13.9 mmol) in dioxane (40 ml) and water (10 ml) was added dropwise with stirring to 2-methoxy[4,6-dichloro-S-triazine] [E10] (5.0 g, 28 mmol) and sodium carbonate (1.6 g, 30 mmol) in dioxane (50 ml) to The reaction mixture was heated to 75° C. for a further 2 hours and cooled overnight. The solvents were removed in vacuo and the crude product extracted with chloroform/water. The organic fraction was dried and evaporated to yield the product [E14] as a pale yellow oil (7.1 g, 70%).

δ_{H} (500 MHz; CDCl₃); 4.4-4.2 (brm, 2H, NHCH(CH₃)CH₂OCH₂), 3.9 (s, 6H, OCH₃), 3.7-3.3 (brm, 10H, NHCH(CH₃)CH₂OCH₂CH(CH₃), 1.25 (brs, 6H, NHCH(CH₃)CH₂OCH₂), 1.10 (brs, 6H, NHCH(CH₃)CH₂OCH₂CH(CH₃);

### Example 15

### Synthesis of 2,2′-Triethyleneglycoldiamino-bis[4,6-dichloro-S-triazine] (Jeffamine EDR-148) [E15]

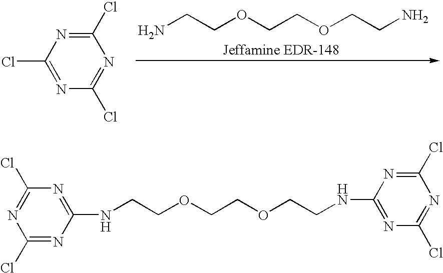

A solution of Jeffamine EDR148 (16.05 g, 110 mmol) and sodium hydroxide (9.5 g, 230 mmol) in water (70 ml) was added dropwise with stirring, over two hours at 0° C. to a solution of cyanuric chloride (40.0 g, 220 mmol) in THF (400 ml). The reaction temperature was maintained below 5° C. during the addition. The reaction mixture was then allowed to warm slowly to room temperature and stirred for a further hour. The reaction mixture was filtered and the filtrate evaporated to give a white solid. This was washed with acetone and water to yield the product [E15] (40 g, 83%).

δ_{H} (500 MHz; CDCl₃); 9.1 (t, 2H, NH), 3.53 (m, 8H, NCH₂CH₂OCH₂) 3.45 (m, 4H, NCH₂CH₂OCH₂); δ_{c} (125 MHz; CDCl₃) 170.0,169.0, 164.7, 69.5, 68.1, 40.2;

### Example 16

### Synthesis of 2,2′-Triethyleneglycoldiamino-bis[4-chloro-6-propylamino-S-triazine] [E16]

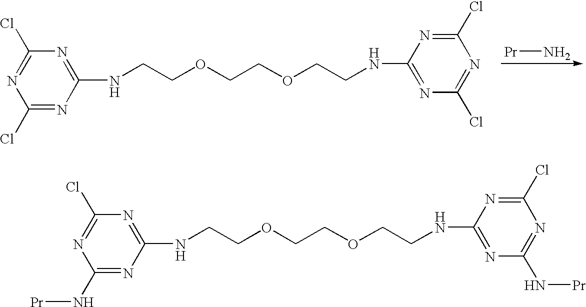

Bis(triazine [E15] (10.0 g, 23 mmol) was added to a vigorously stirred solution of propylamine (2.7 g, 45 mmol) and sodium bicarbonate (3.8 g, 48 mmol) in water (40 ml) and acetone (125 ml). The reaction mixture was heated to 45° C. for 1 hour. After cooling, the solvents were removed by rotary evaporation to give a white solid. This washed with water to yield the product [E16] (10.2 g, 93%).

δ_{H} (500 MHz; CDCl₃); 4.25 (brm, 2H, NHCH(CH₃)CH₂0CH₂), 3.3-3.7 (brm, 12H, NHCH(CH₃)CH₂OCH₂CH(CH₃) plus NHCH₂CH₂CH₃), 1.55 (br, 4H, NHCH₂CH₂CH₃), 1.20 (brs, 6H, NHCH(CH₃)CH₂OCH₂), 1.13 (brs, 6H, NHCH(CH₃)CH₂OCH₂CH(CH₃), 0.92 (br, 6H, NHCH₂CH₂CH₃);

### Example 17

### Synthesis of 2,2′-Triethyleneglycoldiamino-bis[4-chloro-6-methoxy-S-triazine [E17]

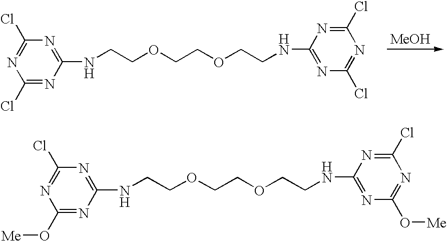

A solution of 2-methoxy[4,6-dichloro-S-triazine] [E10] (5.0 g, 28 mmol) in acetone (150 ml) was added dropwise with stirring to Jeffamine EDR148 (2.06 g, 14 mmol) and sodium carbonate (1.64 g, 16 mmol) in dioxane (100 ml) and water (250 ml). The reaction mixture was heated to 75 ° C. for a further 2 hours and cooled overnight. The solvents were removed in vacuo and the crude product extracted with chloroform/water. The organic fraction was dried and evaporated to yield the product [E17] as a white solid (8.1 g, 84%).

δ_{H} (500 MHz; CDCl₃); 3.9 (s, 6H OCH₃), 3.66-3.62 (m, 12H, NCH₂CH₂OCH₂)

### Example 18

### Synthesis of Ethyl [(4,6-dichloro-1,3,5-triazin-2-yl)oxy]acetate [E18]

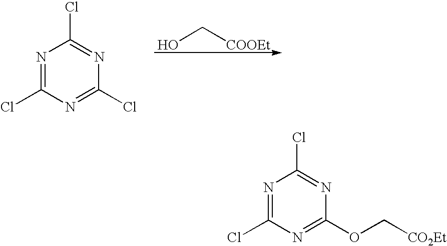

To a 250 ml flask containing cyanuric chloride (9.23 g, 50 mmol) in 100 ml acetone, a solution of ethyl glycolate (4.0 g, 38.46 mmol) and 2,6-lutidine (5.35 g, 50 mmol) in 30 ml acetone was added dropwise at 0° C. After addition, the reaction mixture was kept stirring at 0° C. for 2 hr. Then the mixture was warmed to r. t. overnight, filtrated, and the filtrate was discoloured with charcoal. After removal of acetone, the residue was purified by column chromatography (eluate: hexane/dichloromethane=4/1) to give a viscous liquid [E18] (7.73 g , 79.9%); ¹H NMR (400 MHz, δ, ppm, CDCl₃) 1.29 (t, 3H), 4.28 (q, 2 H), 4.50 (s, 2H); MS-ESI 252 (M+H⁺), 274 (M+Na⁺).

### Example 19

### Mono-chloro ethyl glycolate triazine derivative of Jeffamine D-400 [E19]

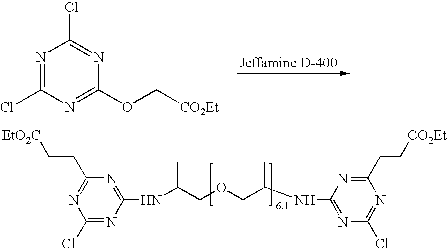

To a 250 ml flask containing ethyl [(4,6-dichloro-1,3,5-triazin-2-yl)oxy]acetate [E18] (7.73 g, 30.7 mmol) in 50 ml THF and sodium carbonate (1.63 g, 15.3 mmol) in 30 ml water, a solution of Jeffamine D-400 (6.14 g, 15.3 mmol) in 30 ml THF was added dropwise at 0° C. After addition, the reaction mixture was kept stirring overnight at r.t. After removal of THF, the water solution was extracted with dichloromethane (2×70 ml), and the organic phase was washed with brine, dried over sodium sulfate. After removal of the solvent, a slight yellow liquid was obtained [E19] (12.5 g, 98%): ¹H NMR (400 MHz, δ, ppm, CDCl₃) 1.10˜1.30 (m, 30 H), 3.46˜3.61(m, 24 H), 4.22˜4.27 (m, 4H), 4.84˜4.94 (m, 4 H) ; MS-ESI 677+58n (M+H⁺) (n=0˜7).

### Example 20

### Mono-chloro sodium glycolate triazine Derivative of Jeffamine D-400 [E20]

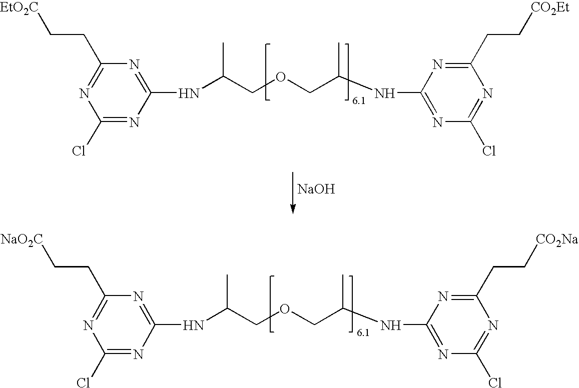

To a 250 ml flask containing mono-chloro ethyl glycolate triazine derivative of Jeffamine [E19] (12.5 g, 15.0 mmol) in 70 ml DMF, was added dropwise a solution of sodium hydroxide (1.22 g, 30.5 mmol) at r.t., after addition, the 10 reaction mixture was kept stirring overnight. After removal of water and DMF in vacuum., the residue was washed with acetone and hexane to give a white solid [E20] (9.3 g, 75.6%): ¹H NMR (400 MHz, δ, ppm, DMSO-d₆) 1.00˜1.07 (m, 24H), 3.29˜3.52 (m, 27 H), 3.86˜4.12 (m, 2H), 4.35˜4.36 (m, 4 H), 8.12˜8.23 (m, 2 H); MS-ESI 689+58n (M+Na⁺) (n=0˜7)

### APPLICATION EXAMPLES

The synthesised cross-linkers were pad applied to cotton sheeting fabric (20×20 cm) at 100% pick-up from solvent (water or dimethylacetamide (DMAc)).

The fabric swatches were then dried, followed by an iron cure on high setting (cotton/linen) for the time specified.

In each case a sodium carbonate acid binding agent was included at a 2 mole equivalent level.

If the crosslinker was applied from DMAc, the sodium carbonate was firstly applied to the fabric from water, allowed to dry then the DMAc solution applied. If the crosslinker was applied from water, the sodium carbonate was co-dissolved in the aqueous solution and applied to the fabric at the same time as the crosslinker.

After curing, the swatches were conditioned at 20° C., 65% relative humidity then the crease recovery angle (CRA) and break strength were measured.

The CRA was measured using a method based on BS1553086. A sample of fabric (25 mm×50 mm) was folded in half forming a sharp crease and held under a weight of 1 kg for 1 minute. On releasing the sample the crease opens up to a certain degree. After 1 minute relaxation time, the angle is measured. The fabric is tested in the warp direction only (hence maximum CRA is 180°). Higher CRA therefore indicates less wrinkled fabric.

In-order to determine break strength, four replicates (150×100 mm each) were conditioned overnight at 20° C. and 65% relative humidity. Each was clamped lengthways in the jaws of a Testometric Tensile Tester, the jaw separation being 75 mm. The fabric sample was held in the jaws by a 25×25 mm rubber pad so when tension was applied upon the sample it was concentrated on the centre 25 mm width strip. Each replicate was pulled at 40 mm/min until breakage at which point the break load was measured (kgf).

### Example 21

### Application of Taurine Derivative of 1,8-Bis-(4,6-dichloro-[1,3,5]triazin-2-yloxy)-3,6-diox-octane [E2]

Results obtained by application of the taurine derivative of 1,8-Bis-(4,6-dichloro-[1,3,5]triazin-2-yloxy)-3,6-diox-octane [E2] from water are shown in table 1 below. 1,8-Bis-(4,6-dichloro-[1,3,5]triazin-2-yloxy)-3,6-diox-octane [E1] was applied from DMAc.

TABLE 1

| Level, Treatment, Ironing Time | CRA | Break Strength |
|---|---|---|
| UT Control | 75 | 39.9 |
| 2% [E1] (20 s iron) | 104 | 23.3 |
| 2% [E2] (20 s iron) | 92 | 36.6 |
| 2% [E2] (60 s iron) | 90 | 32.9 |
| 5% [E2] (20 s iron) | 105 | 30.9 |

From these results it can be seen that less creasing (higher CRA) was obtained from fabric treated with [E2] than with the untreated samples (UT). The results also show that the fabric treated with [E2] had less strength loss than [E1] while still retaining a good CRA score. This is believed to be because [E2] still has good mobility when cross-linked to the fabric compared to [E1], which forms rigid short cross-links at both triazine groups. The results also show that [E2] is reactive at short ironing cure times (20 s)—further ironing does not improve the CRA. Increasing the amount of [E2] on the fabric also increases the CRA while minimising the decrease in strength.

### Example 22

### Application of Glycine Derivative of 1,8-Bis-(4,6-dichloro-[1,3,5]triazin-2-yloxy)-3,6-diox-octane [E3]

Results obtained by application of the glycine derivative of 1,8-Bis-(4,6-dichloro-[1,3,5]triazin-2-yloxy)-3,6-diox-octane [E3] from water are shown in table 2 below.

TABLE 2

| Level, Treatment, Ironing Time | CRA | Break Strength |
|---|---|---|
| UT Control | 75 | 39.9 |
| 2% [E3] (20 s iron) | 86 | 34.7 |
| 2% [E3] (60 s iron) | 88 | 34.1 |

From these results it can be seen that less creasing (higher CRA) was obtained with the treated samples than with the untreated samples (UT) and the treated samples did not result in a large decrease in strength. In addition, longer ironing times did not significantly increase the CRA.

### Example 23

### Application of Glycolic Acid Derivative of 1,8-Bis-(4,6-dichloro-[1,3,5]triazin-2-yloxy)-3,6-diox-octane [E4]

Results obtained by application of the of glycolic acid derivative of 1,8-Bis-(4,6-dichloro-[1,3,5]triazin-2-yloxy)-3,6-diox-octane [E4] from water are shown in table 3 below.

TABLE 3

| Level, Treatment, Ironing Time | CRA | Break Strength |
|---|---|---|
| UT Control | 75 | 39.9 |
| 2% [E4] (20 s iron) | 83 | 38.4 |
| 2% [E4] (60 s iron) | 87 | 36.1 |

From these results it can be seen that less creasing (higher CRA) was obtained with the treated samples than with the untreated samples (UT) and the treated samples did not result in a large decrease in strength.

### Example 24

### Application of Bis-(2-chloro-4-propoxy-triazine)-6-diethyleneglycol [E6]

Results obtained by application of Bis-(2-chloro-4-propoxy-triazine)-6-diethyleneglycol [E6], bis-(2,4-dichloro-triazine)-6-diethyleneglycol [E5] and 4,6-dichloro-N-methyl-1,3,5-triazin-2-amine [E7] are shown in table 4. All materials were applied from DMAc.

TABLE 4

| Level, Treatment, Ironing Time | CRA | Break Strength |
|---|---|---|
| UT Control | 76 | 37.7 |
| 2% [E6] (20 s iron) | 101 | 32 |
| 2% [E5] (20 s iron) | 100 | 25.8 |
| 2% [E7] (20 s iron) | 106 | 19 |

The results show that [E6] provides less creasing (higher CRA) than the untreated control (UT) and a comparable CRA with [E5]. The results also show that [E6] minimises the decrease in strength whereas [E5] has a large decrease in strength (due to its rigid cross-linking of the fabric). The results also show that the cross-linking occurred under short ironing times. The results also show the benefit of having a flexible spacer connecting the cross-linking groups. Fabric treated with [E7] (which does not contain a flexible spacer) has a large decrease in strength compared to [E6].

### Example 25

### Application of 2,2′-[D400]Polyoxypropylene-diaminobis[4-chloro-6-propylamino-s-triazine] [E9]

Results obtained by application of 2,2′-[D400]Polyoxypropylenediaminobis[4-chloro-6-propylamino-s-triazine] [E9] and 2,2′-[D400]Polyoxypropylenediaminobis [4,6-dichloro-s-triazine] [E8] are shown in table 5. Both materials were applied from DMAc.

TABLE 5

| Level, Treatment, Ironing | | |
|---|---|---|
| Time | CRA | Break Strength |
| UT Control | 79 | 38.5 |
| 2% [E8] (20 s iron) | 96 | 31.0 |
| 2% [E9] (20 s iron) | 82 | 37.9 |
| 3% [E9] (60 s iron) | 93 | 36.0 |
| 5% [E9] (60 s iron) | 104 | 34.1 |

The results show that fabric treated with [E9] and ironed for 60 s gives less creasing (higher CRA) that the untreated control (UT) and also minimises the decrease in strength compared to [E8]. The results also show that crosslinkers where flexible spacer is linked by NH and the cellulose-unreactive groups are also linked by NH require a longer ironing time (60 s) to activate the chemistry compared to both O/O and NH/O linkages.

### Example 26

### Application of 2,2′-[D400]Polyoxypropylene-diaminobis[4-chloro-6-methoxy-S-triazine] [E11]

Results obtained by application of 2,2′-[D400]Poly-oxypropylenediaminobis[4-chloro-6-methoxy-S-triazine] [E11] from DMAc are shown in table 6.

TABLE 6

| Level, Treatment, Ironing Time | CRA | Break Strength |
|---|---|---|
| UT Control | 75 | 37.3 |
| 2% [E11] (20 s iron) | 87 | 34.1 |
| 5% [E11] (20 s iron) | 100 | 32.8 |

The results show that fabric treated with [E11] gives less creasing (higher CRA) than the untreated control (UT) and also minimises the decrease in strength at short iron times (20 s). The results also show that higher application levels of the material result in higher CRA.

### Example 27

### Application of 2,2′-[D230]Polyoxypropylene-diaminobis[4-chloro-6-propylamino-S-triazine] [E13]

Results obtained by application of 2,2′-[D230]Polyoxy-propylenediaminobis[4-chloro-6-propylamino-S-triazine] [E13] from DMAC are shown in table 7.

TABLE 7

| Level, Treatment, Ironing Time | CRA | Break Strength |
|---|---|---|
| UT Control | 78 | 32.6 |
| 2% [E13] (60 s iron) | 89 | 34.1 |

The results show that fabric treated with [E13] gives less creasing (higher CRA) than the untreated control (UT) and also minimises the decrease in strength loss. Higher iron times (60 s) are required as [E13] contains only NH linkages.

### Example 28

### Application of 2,2′-[D230]Polyoxypropylene-diaminobis[4-chloro-6-methoxy-S-triazine] [E14]

Results obtained by application of 2,2′-[D230]Polyoxypropylenediaminobis[4-chloro-6-methoxy-S-triazine] [E14] from DMAc are shown in table 8.

TABLE 8

| Level, Treatment, Ironing Time | CRA | Break Strength |
|---|---|---|
| UT Control | 78 | 32.6 |
| 2% [E14] (20 s iron) | 89 | 32.3 |
| 5% [E14] (20 s iron) | 99 | 28.3 |

The results show that fabric treated with [E14] gives less creasing (higher CRA) than the untreated control (UT) and also minimises the decrease in strength loss. Higher levels of material also results in higher CRA.

### Example 29

### Application of 2,2′-Triethyleneglycoldiamino-bis[4-chloro-6-propylamino-S-triazine] [E16]

Results obtained by application of 2,2′-Triethyleneglycol-diaminobis[4-chloro-6-propylamino-S-triazine] [E16] from DMAc are shown in table 9.

TABLE 9

| Level, Treatment, Ironing Time | CRA | Break Strength |
|---|---|---|
| UT Control | 76 | 37.7 |
| 5% [E16] (60 s iron) | 85 | 35.2 |

The results show that fabric treated with [E16] gives less creasing (higher CRA) than the untreated control (UT) and also minimises the decrease in strength loss. Higher iron times (60 s) are required as [E16] contains only NH linkages.

### Example 30

### Application of 2,2′-Triethyleneglycol-diaminobis[4-chloro-6-methoxy-S-triazine [E17]

Results obtained by application of 2,2′-Triethyleneglycoldiaminobis[4-chloro-6-methoxy-S-triazine] [E17] from DMAc are shown in table 10.

TABLE 10

| Level, Treatment, Ironing Time | CRA | Break Strength |
|---|---|---|
| UT Control | 76 | 37.7 |
| 2% [E17] (20 s iron) | 88 | 31.0 |
| 5% [E17] (20 s iron) | 99 | 29.0 |

The results show that fabric treated with [E17] gives less creasing (higher CRA) than the untreated control (UT) and also minimises the decrease in strength loss. Higher levels of material also result in higher CRA.

### Example 31

### Application of Mono-chloro sodium glycolate triazine derivative of Jeffamine D-400 [E20]

Results obtained by application of the mono-chloro sodium glycolate triazine derivative of Jeffamine D-400 from water are shown in table 11.

TABLE 11

| Level, Treatment, Ironing Time | CRA | Break Strength |
|---|---|---|
| UT Control | 73 | 34.7 |
| 5% [E20] (20 s iron) | 96 | 27.2 |

The results show that fabric treated with [E20] gives less creasing (higher CRA) than the UT control and also minimises the strength loss.

1. A laundry treatment composition comprising:
a) a textile compatible carrier,
b) an acid binding agent
c) a cellulose cross-linking agent which is water soluble or soluble in a water miscible solvent
in which the cellulose cross-linking agent comprises two or more mono-reactive s-triazine moieties bridged by a flexible bridging moiety, said bridging moiety comprising at least one aliphatic polyoxyalkylene chain, and wherein each s-triazine moiety is provided with a hydrophilic or a non-hydrophilic substituent group.

2. A composition according to claim 1 wherein the hydrophilic moiety is selected from the group consisting of hydroxy acids, amino acids, mercaptans and amino-sulphonates or mixtures thereof, each in their salt forms.

3. A composition according to claim 1 wherein the non-hydrophilic moiety has a chain length of from C1 to C10.

4. A composition according to claim 1 wherein the cellulose cross-linking agent is represented by the general structure (1):
(R₁)(X₁)T-L₁-B-L₂-T(X₂)(R₂) (1)
wherein:
R1 and R2 are cellulose-unreactive substituent groups on s-triazine (T) and may be the same or different,
X1 and X2 are leaving groups on s-triazine (T) which are lost on reaction with cellulose and may be the same or different,
L1 and L2 are linking groups, and may be the same or different or absent,
B is a bridging group comprising or consisting of at least one aliphatic polyoxyalkylene chain.

5. A composition according to claim 4 wherein the bridging group B is 2-100 atoms in length.

6. A composition according to claim 4 wherein the cellulose cross-linking agent is of the formula: 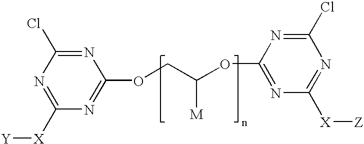
Wherein:
n is 1-10, preferably 1-7
M is independently H or methyl
X is independently S, O or NH
Y and Z are independently cellulose-unreactive substituents.

7. A composition according to claim 6 wherein n is 2-4 and M is H.

8. A composition according to claim 6 wherein X is —NH— and Y and Z are independently selected from the group comprising:
—CH₂—CH₂—SO₃⁻,
—CH₂—COO⁻,
—CH₂—CH₂—CH₃,

9. A composition according to claim 6 wherein the cellulose cross-linking agent is selected from:

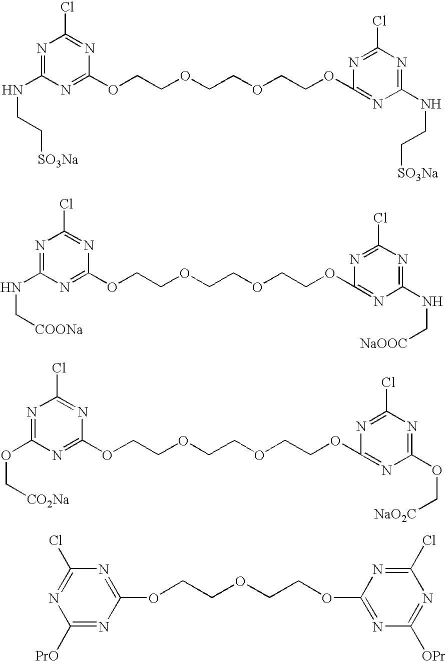

10. A composition according to claim 4 wherein the cellulose cross linking agent is of the formula: 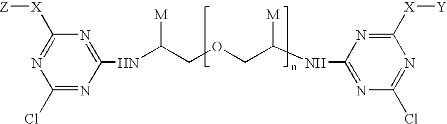
Wherein:
n is 1-10, preferably 1-7
M is independently H or methyl
X is independently S, O or NH
Y and Z are independently cellulose-unreactive substituents.

11. A composition according to claim 10 wherein n is 2-7 and M is H or methyl.

12. A composition according to claim 10 wherein X is —O— and Y and Z are independently selected from the group comprising:
—CH₃,
—CH₂—COO⁻,
—CH₂—CH₂—CH₃,

13. A composition according to claim 10 wherein the cellulose cross linking agents is selected from:

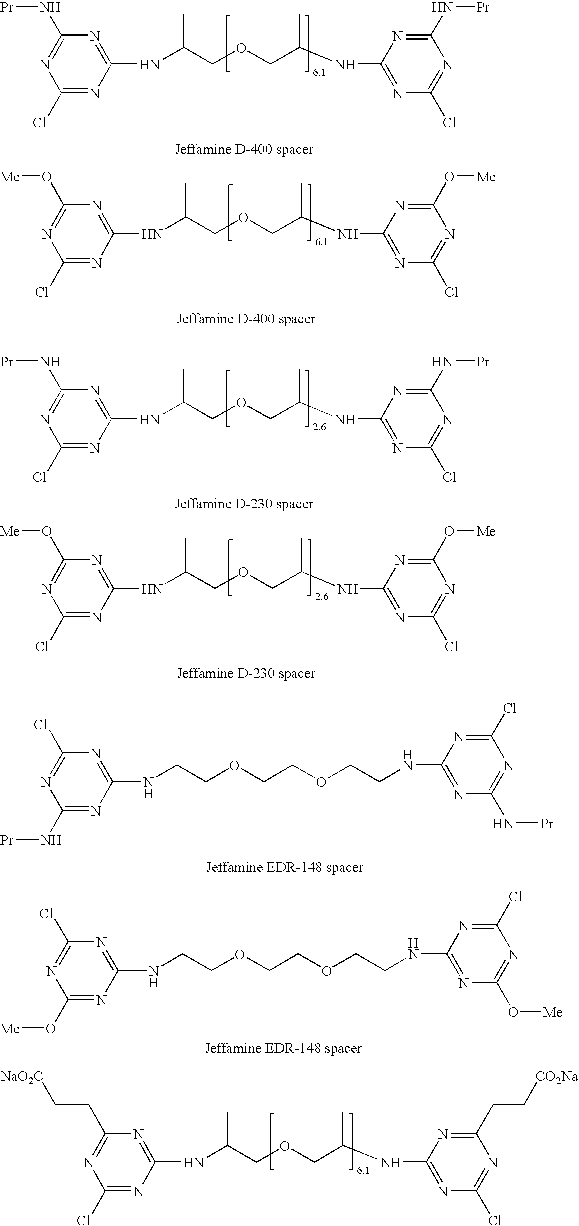

14. A method for treatment of cellulosic textiles which comprises the steps of:
a) applying to the textile a composition according to claim 1, and,
b) heating the textile so as to cause a reaction between the said composition and the textile.
